(19) United States
(12) Patent Application Publication
(10) Pub. No.: US 2006/0234721 A1
(43) Pub. Date: Oct. 19, 2006

(54) Facilitating routing requests received in wireless communication devices

(76) Inventors: Kevin Fallis, Overland Park, KS (US); Dan O'Bryan, Kansas City, MO (US); Lang Zhang, Cornwall (CA); Chris Blackburn, Overland Park, KS (US)

Correspondence Address: MACPHERSON KWOK CHEN & HEID LLP, 1762 TECHNOLOGY DRIVE, SUITE 226, SAN JOSE, CA, 95110, US

(21) Appl. No.: 11/105,735

(22) Filed: Apr. 13, 2005

(51) Int. Cl. H04Q 7/20

(52) U.S. Cl. 455/455

(57) ABSTRACT

A method and apparatus are disclosed for facilitating a routing request received in a wireless communication device of a wireless subscriber. The method comprises receiving a first string of data input by the wireless subscriber wherein the first string comprises a predetermined format recognizable by a communication application residing on the wireless communication device, and resolving the first string of data into a second string of data via the communication application, the second string of data comprising a predetermined format recognizable by a host system adapted to establish a wire-based communication between the wireless communication device and a destination communication device based on the second string of data.

### RELATED APPLICATIONS

This application is related to the co-filed patent application entitled “ROUTING WIRELESS COMMUNICATIONS”, filed on Apr. 13, 2005 as U.S. Ser. No. [M-15812 U.S.], the details of which are herein incorporated by reference.

### FIELD OF THE INVENTION

This invention relates to wireless communications. More particularly, the present invention is directed to facilitating the routing of wireless communications.

### BACKGROUND OF THE INVENTION

Wireless communication devices such as cell phones and personal digital assistants (PDA) are becoming increasingly widespread in use. Wireless communication offers the convenience and flexibility of allowing a user to become mobile while remaining accessible for communication with others so long as the user remains within a wireless zone of coverage.

Generally, a wireless device such as a cell phone communicates with a base-station administering the calls in the cell. The base station typically receives a calling request by a user such as via a telephone number of a destination device that is input by the user via a phone pad or voice recognition device. The base-station then routes the call through secondary stations until a routing link is established with the destination device. The call is then established between the user and the destination device based on the routing link.

While in widespread use today, the foregoing routing approach is not without shortcomings. One such short coming is that once a telephone number is input by a user, the user is not allowed to select which routing link the requested call is to take in reaching the destination device. Since the links through which a call is routed are often owned by different service providers who may charge different rates based on the medium through which a call is routed, the total cost of the placed call may vary based on the selected links. For example, for international calls, utilizing intermediary land-based links such as sub-oceanic copper or fiber-optic wires often results in substantial savings to the user over wireless links such as satellite. Unfortunately, the user is not provided with a choice as to which medium to have his or her calls routed through and thus may have to unwillingly bear the higher cost of a satellite intermediary link when placing calls. This scenario also occurs when a user receives a long distance call from a caller for which the user is often charged with the difference in fees between the caller's charges and the user's higher wireless charges.

Accordingly, there is a need in the art for providing a wireless user with an ability to select a desired cost-efficient link for routing of the wireless calls made or received by the user.

### SUMMARY

At least one aspect of the invention can be regarded as a method for facilitating a routing request received in a wireless communication device of a wireless subscriber. The method comprises receiving a first string of data input by the wireless subscriber wherein the first string comprises a predetermined format recognizable by a communication application residing on the wireless communication device; and resolving the first string of data into a second string of data via the communication application, the second string of data comprising a predetermined format recognizable by a host system adapted to establish a wire-based communication between the wireless communication device and a destination communication device based on the second string of data.

At least one aspect of the invention can also be regarded as a method for configuring a subscriber identity module (SIM) of a wireless communication device of a wireless subscriber for facilitating a routing request received in the wireless communication device. The method comprises selecting a portion of the SIM adapted for receipt of encoding instructions, and encoding the selected portion with encoding instructions wherein the encoding instructions enable the SIM to recognize a first string of data input by the wireless subscriber in a predetermined format and to resolve the first string of data into a second string of data comprising a predetermined format recognizable by a host system adapted to establish a wire-based communication between the wireless communication device and a destination communication device based on the second string of data.

At least one aspect of the invention can also be regarded as a subscriber identity module (SIM) in communication with a wireless communication device of a wireless subscriber. The SIM comprises an open environment portion adapted for receipt of encoding instructions; and a communication application residing on the open portion and adapted to configure the SIM to recognize a first string of data input by the wireless subscriber in the wireless communication device in a predetermined format, and to resolve the first string of data into a second string of data comprising a predetermined format recognizable by a host system adapted to establish a wire-based communication between the wireless communication device and a destination communication device based on the second string of data.

### BRIEF DESCRIPTION OF THE DRAWINGS

FIG. 1 illustrates an exemplary communication system in which the method of the present invention may be practiced.

FIG. 2 is a flow diagram illustrating a method according to an embodiment of the present invention.

FIGS. 3A-B are flow diagrams further illustrating the method of FIG. 2.

FIGS. 4A-B further illustrate the exemplary communication system of FIG. 1 in which another method of the present invention may be practiced.

### DETAILED DESCRIPTION OF THE INVENTION

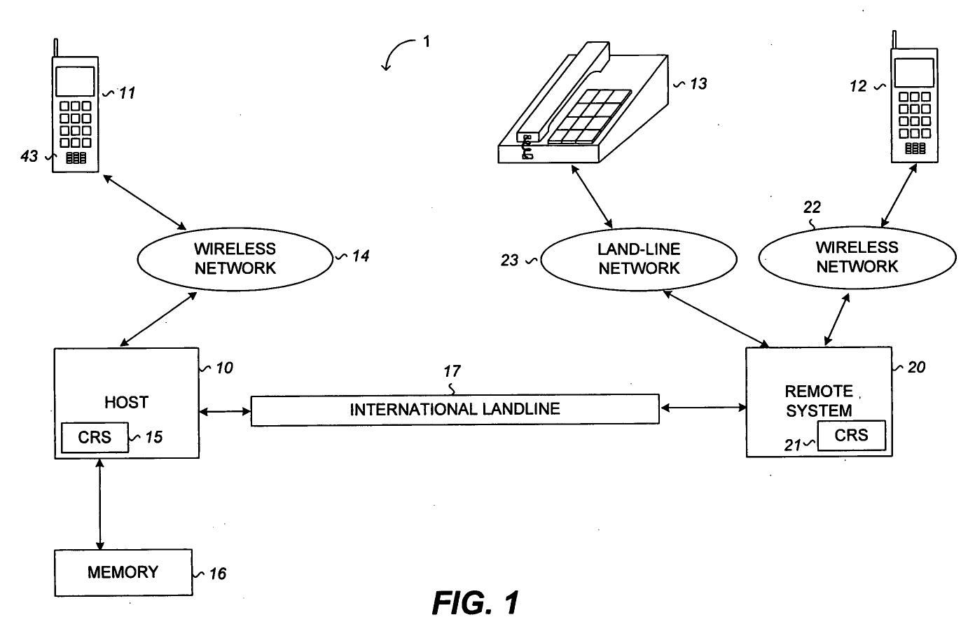

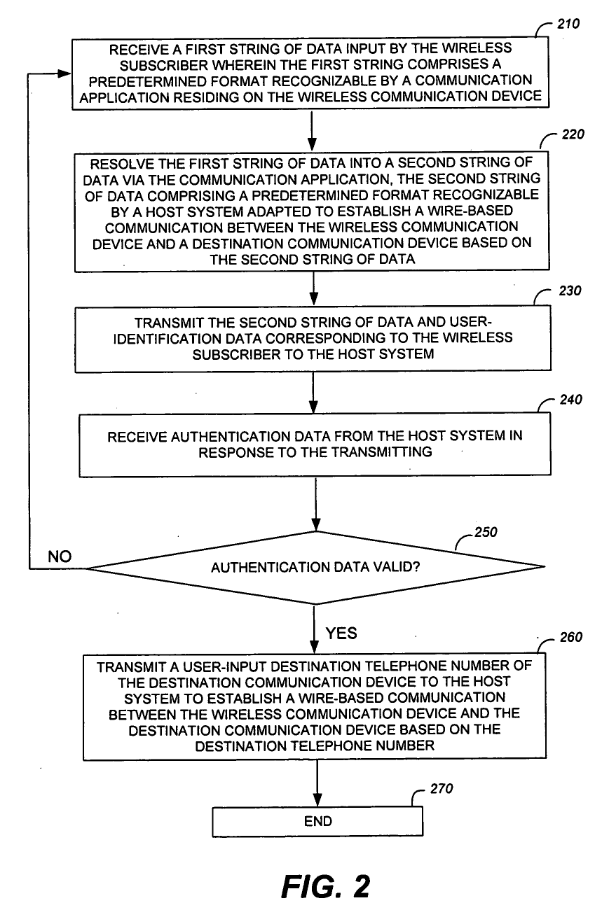

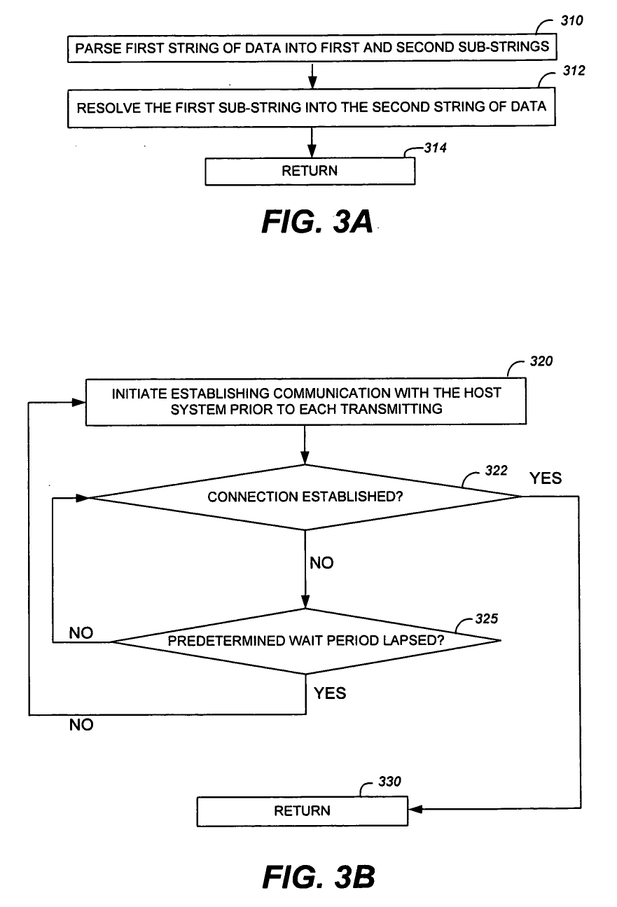

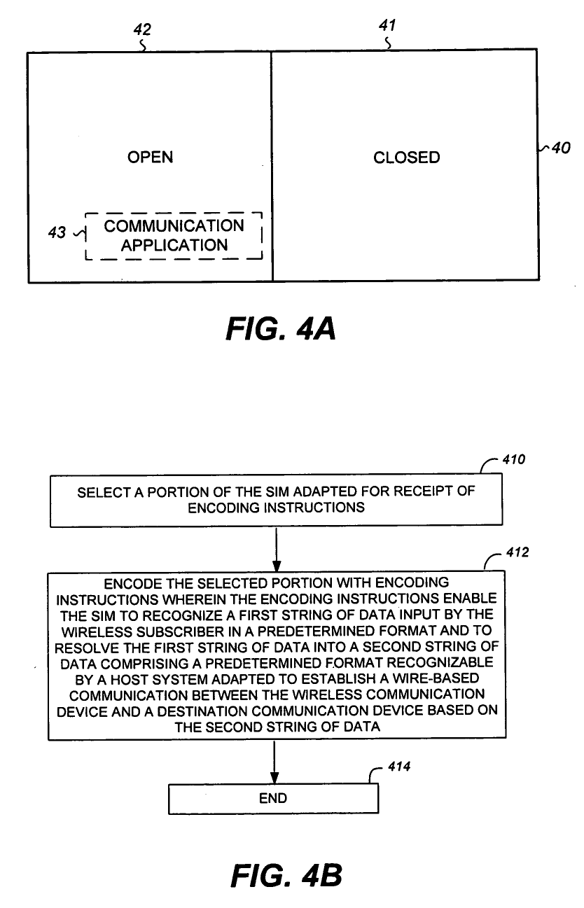

With reference to FIG. 1, an exemplary communication system 1 in which the methods of the present invention maybe practiced is shown. One embodiment of the present invention is the method for facilitating a routing request received in a wireless communication device 11 of a wireless subscriber as illustrated via the flow diagram in FIG. 2 and in conjunction with FIG. 1. As shown in FIG. 2, the process begins in block 210 in which a first string of data input by the wireless subscriber is received in the communication device 11, such as a cell phone, wherein the first string comprises a predetermined format recognizable by a communication application 43 residing on the wireless communication device 11. In an exemplary embodiment, the communication application 43 is a Java Calling Card Application (JCCA). In an exemplary embodiment, the first string comprises a data string of characters and/or numeric data having a predetermined format, such as *888, that is recognizable by the communication application as a request to initiate a routing of the wireless call. Next, in block 220, the communication application 43 resolves the first string of data into a second string of data, as described below and in greater detail in conjunction with FIG. 3A. The second string of data comprises a predetermined format recognizable by a host system 10. The host system 10 is adapted to establish (based on the second string of data) a wire-based communication, such as via wire-based medium 17, between the wireless communication device 11 and a destination communication device, such as wire-based communication device 13 or wireless communication device 12, via land-line network 23 or wireless network 22, respectively. In an exemplary embodiment, the wireless communication device 11 comprises a subscriber identity module (SIM) card 40, as described below and in greater detail in conjunction with FIG. 4A, wherein the communication application resides 43 in the SIM card 40 and wherein the second string of data comprises a unique code embedded on the SIM card 40.

In an exemplary embodiment, host system 10 performs the forgoing routing tasks via a call routing system (CRS) application 15 residing in host system 10 adapted to communicate with the SIM card 40 of the wireless communication device 11. Suitably, the SIM card 40 communicates with the CRS application 15 via the use of dual tone multi frequency (DTMF) tones. In an exemplary embodiment, host system 10 is in communication with a memory subsystem 16, and a remote host system 20 in which a remote CRS application 21 resides, such as that described in the above-referenced patent application. In an exemplary embodiment, at least one of the wireless communication devices 11 or 12 is a Global System for Mobile communication (GSM) device.

Returning to FIG. 2, the flow proceeds next to block 230 in which the second string of data and user-identification data corresponding to the wireless subscriber are transmitted to the host system 10, such as via wireless network 14. In an exemplary embodiment, the user-identification data comprises one or more of 1) caller identification data corresponding the wireless subscriber, 2) equipment-identification data corresponding to the wireless communication device 11 of the wireless subscriber, and 3) a personal identification number (PIN) corresponding to the wireless subscriber. Next, in block 240, authentication data is received from the host system 10 in response to the transmitting. Next in decision block 250, it is determined if the authentication data is valid, such as signifying that the wireless subscriber is a valid the wireless subscriber with an active account. If in decision block it is determined that the authentication data is not valid, the flow then returns to block 210 wherein the user is notified of the invalid entry and prompted to reenter a different entry.

If in decision block it is determined that the authentication data is valid, the flow then proceeds to block 260 in which a user-input destination telephone number of the destination communication device, such as device 12 or 13, are transmitted to the host system 10 to establish a wire-based communication between the wireless communication device and the destination communication device based on the destination telephone number, as described in the above-referenced patent application. The flow then proceeds to block 270 in which the overall process ends.

FIG. 3A further illustrates the resolving process described in block 220 of FIG. 2. As shown in FIG. 3A, the process begins in block 310 in which the first string of data is parsed by the communication application 43 into a first sub-string and a second sub-string. In an exemplary embodiment, the first sub-string comprises the above described predetermined format, such as *888, that is recognizable by the communication application 43 as a request to initiate a routing of the wireless call. The second sub-string comprises the user-input destination telephone number. In this way, a user can enter the request to initiate routing followed by the destination telephone number in a single sequence, such as entering *8887145551212. The communication application 43 then parses the single sequence into a first sub-string *888 and a second sub-string comprising the destination telephone number of 714-555-1212. Next, in block 312, the communication application 43 resolves the first sub-string into the second string of data for transmitting to the host system 10 as described above in conjunction with FIG. 2. The flow then proceeds to block 314 for returning to block 220 of FIG. 2.

FIG. 3B further illustrates the transmitting process described in blocks 230 and 260 of FIG. 2. As shown in FIG. 3B, the process begins in block 320 in which establishing communication with the host system 10 is initiated prior to each transmitting. Next in block 322, it is determined if a connection was established with the host system 10 based on the initiating attempt of block 320. If in decision block 322 it is determined that the connection was not established with the host system 10, the flow then proceeds to decision block 325 in which a predetermined period is waited for the communication to establish. If in decision block 325, it is determined that the predetermined period has lapsed without the communication being established, the flow then returns to block 320 wherein another establishing communication with the host system 10 is initiated. Returning to decision block 322, if it is determined that the connection was established with the host system 10, such as either immediately or during the predetermined period, the flow then proceeds to block 330 for returning to transmitting blocks 230 or 260 of FIG. 2.

FIG. 4A further illustrates an exemplary subscriber identity module (SIM) card 40 of the wireless communication device 11 of a wireless subscriber used in conjunction with the exemplary communication system 1 of FIG. 1. FIG. 4B illustrates another method of the present invention for configuring the SIM card 40 of FIG. 4A for facilitating a routing request received in the wireless communication device 11. As shown in FIG. 4B, the process begins in block 410 in which a portion 42 of the SIM card 40 adapted for receipt of encoding instructions is selected. In an exemplary embodiment, the SIM card 40 is manufactured with a closed environment portion 41 that is not adapted for encoding, such as a read-only portion, and an open environment portion 42 that is adapted for encoding, such as a read/writeable portion. Next, in block 412, the selected portion 42 is encoded with encoding instructions comprising the communication application 43, such as a Java Calling Card Application (JCCA). As described above in conjunction with FIG. 2, the encoded communication application 43 enables the SIM card 40 to recognize a first string of data input by the wireless subscriber in a predetermined format and to resolve the first string of data into a second string of data comprising a predetermined format recognizable by the host system 10 adapted to establish a wire-based communication between the wireless communication device 11 and a destination communication device 12 or 13 based on the second string of data. The flow then proceeds to block 414 in which the overall process ends.

In an exemplary embodiment, the JCCA of the communication application 43 uses J2ME (Java 2 Mobile Edition) Wireless Toolkit v2.1 and the Wireless Telephony Application Interface. The Java 2 Platform, Micro Edition (J2ME) Wireless Toolkit is a toolbox for developing wireless applications that are based on J2ME's Connected Limited Device Configuration (CLDC) and Mobile Information Device Profile (MIDP), and designed to run on cell phones, mainstream personal digital assistants, and other small mobile devices. Suitably, the toolkit used in conjunction with the JCCA of the communication application 43 includes the emulation environments, performance optimization and tuning features, documentation.

In an exemplary embodiment, the JCCA of the communication application 43 conforms to the GSM 11.14 standard for SIM cards 40. Suitably, the SIM 40 carries the subscriber's account information. The European Telecommunications Standards Institute (ETSI) has published a number of standards covering SIMs and their relationship to the GSM phone which describe the interface between a wireless device 11 and a SIM card 40 which allows for the SIM card 40 to initiate communication to the wireless device 11. Suitably, the code running in a SIM card 40 card has two application program interfaces (API): 1) an inward looking API for services on the SIM card 40, and 2) an outward looking API for services on the wireless device 11. In an exemplary embodiment, the inward-looking API on the SIM card 40 comprises a file system and the encryption algorithms used to authenticate keys. In an exemplary embodiment, the outward-looking API on the SIM card 40 contains the following exemplary functions: 1) DisplayText: Displays text on the display window of the wireless device 11, 2) GetinKey: Gets one key hit from the keypad of the wireless device 11, 3) GetInput: Gets a string of characters from the keypad of the wireless device 11, 4) MoreTime: Prevents the wireless device 11 timeout by asking for more processing time, 5) PlayTone: Plays an audio tone in the earpiece and on the wireless device 11, 6) PollInterval: Sets time between STATUS commands from the wireless device 11, 7) Reset: Notifies the wireless device 1 1 of changes in the SIM card 40, 8) SelectItem: Sends a selection list to the wireless device 11 to get user selection, 9) SendShortMessage: Sends a short message to the network, 10) SendSS: Sends a supplementary service request to the wireless device 11, 11) SetUpCalls: Sets up a call on the network, 13) SetUpMenu: Sends a user-selection menu to the wireless device 1 1, which displays it. Suitably, the outward-looking API enables the SIM card 40 to contact an arbitrary node on a telephone network by using the exemplary PlayTone function to communicate with the telephone network.

One advantage of the foregoing feature of the present invention over the prior art is that by using a SIM card 40, a wireless user is provided with the ability to efficiently and easily select a desired cost-efficient link for routing of the wireless calls made by the user via inputting a single string of data.

It should be noted that the various features of the foregoing embodiments were discussed separately for clarity of description only and they can be incorporated in whole or in part into a single embodiment of the invention having all or some of these features.

What is claimed is:

1. A method for facilitating a routing request received in a wireless communication device of a wireless subscriber, the method comprising:
receiving a first string of data input by the wireless subscriber wherein the first string comprises a predetermined format recognizable by a communication application residing on the wireless communication device; and
resolving the first string of data into a second string of data via the communication application, the second string of data comprising a predetermined format recognizable by a host system adapted to establish a wire-based communication between the wireless communication device and a destination communication device based on the second string of data.

2. The method as defined in claim 1, further comprising:
transmitting the second string of data and user-identification data corresponding to the wireless subscriber to the host system; and
receiving authentication data from the host system in response to the transmitting, and if the authentication data is valid:
transmitting a user-input destination telephone number of the destination communication device to the host system to establish a wire-based communication between the wireless communication device and the destination communication device based on the destination telephone number.

3. The method as defined in claim 2, wherein the first string of data further comprises a first sub-string and a second sub-string wherein the second sub-string comprises the user-input destination telephone number.

4. The method as defined in claim 2, wherein the resolving further comprises:
parsing the first string of data into the first and second sub-strings; and
resolving the first sub-string into the second string of data.

5. The method as defined in claim 2, wherein the user-identification data comprises caller identification data corresponding the wireless subscriber.

6. The method as defined in claim 2, wherein the user-identification data comprises an equipment-identification data corresponding to the wireless communication device of the wireless subscriber.

7. The method as defined in claim 2, wherein the user-identification data comprises a personal identification number (PIN) corresponding to the wireless subscriber.

8. The method as defined in claim 1, further comprising:
initiating establishing communication with the host system prior to each transmitting;
determining if a connection was established with the host system based on the initiating during a predetermined period; and
repeating the initiating and the determining until communication is established with the host system.

9. The method as defined in claim 1, wherein the wireless communication device comprises a subscriber identity module (SIM) card and wherein the communication application resides in the SIM card.

10. The method as defined in claim 9, wherein the second string of data comprises a unique code embedded on the SIM card.

11. The method as defined in claim 1, wherein the first string of data comprises at least one of a character and numeric data.

12. The method as defined in claim 1, wherein the wireless communication device is a Global System for Mobile communication (GSM) device.

13. A method for configuring a subscriber identity module (SIM) of a wireless communication device of a wireless subscriber for facilitating a routing request received in the wireless communication device, the method comprising:
selecting a portion of the SIM adapted for receipt of encoding instructions; and
encoding the selected portion with encoding instructions where in the encoding instructions enable the SIM to recognize a first string of data input by the wireless subscriber in a predetermined format and to resolve the first string of data into a second string of data comprising a predetermined format recognizable by a host system adapted to establish a wire-based communication between the wireless communication device and a destination communication device based on the second string of data.

14. The method as defined in claim 13, wherein the encoding instructions comprises a communication application.

15. The method as defined in claim 13, wherein the selected portion of the SIM comprises an open environment portion of the SIM.

16. The method as defined in claim 13, wherein the SIM comprises a SIM card.

17. The method as defined in claim 16, wherein the encoding instructions are embedded on the SIM card.

18. A subscriber identity module (SIM) in communication with a wireless communication device of a wireless subscriber, the SIM comprising:
an open environment portion adapted for receipt of encoding instructions; and
a communication application residing on the open portion and adapted to configure the SIM to recognize a first string of data input by the wireless subscriber in the wireless communication device in a predetermined format, and to resolve the first string of data into a second string of data comprising a predetermined format recognizable by a host system adapted to establish a wire-based communication between the wireless communication device and a destination communication device based on the second string of data.

19. The SIM as defined in claim 18, wherein the SIM comprises a SIM card and wherein the encoding instructions are embedded on the SIM card.

20. The SIM as defined in claim 18, wherein the communication application is further adapted to cause a transmission of the second string of data and user-identification data corresponding to the wireless subscriber to the host system by the wireless communication device, to receive authentication data from the host system in response to the transmission, and if the authentication data is valid, to transmit a user-input destination telephone number of the destination communication device to the host system to establish a wire-based communication between the wireless communication device and the destination communication device based on the destination telephone number.

21. The SIM as defined in claim 20, wherein the communication application is further adapted to initiate establishing communication with the host system via the wireless communication device prior to each transmission, to determine if a connection was established with the host system based on the initiation during a predetermined period, and to repeat the initiation and the determination until communication is established with the host system.

22. The SIM as defined in claim 18, wherein the communication application is further adapted to parse the first string of data into the first and second sub-strings and to resolve the first sub-string into the second string of data.

23. The method as defined in claim 18, wherein the second string of data comprises a unique code embedded on the SIM card.

24. The method as defined in claim 18, wherein the wireless communication device is a Global System for Mobile communication (GSM) device.
